(19) United States
(12) Patent Application Publication
(10) Pub. No.: US 2021/0292918 A1
(43) Pub. Date: Sep. 23, 2021

(54) ELECTROLYZER

(71) Applicant: HONDA MOTOR CO., LTD., Tokyo (JP)

(72) Inventors: Wataru SHIMIZU, Saitama (JP); Toru SUKIGARA, Saitama (JP)

(21) Appl. No.: 17/203,738

(22) Filed: Mar. 16, 2021

(30) Foreign Application Priority Data
Mar. 17, 2020 (JP) 2020-045913

(51) Int. Cl. C25B 1/04; B01J 39/12; C25B 9/23; C25C 3/02

(52) U.S. Cl. CPC C25B 1/04; C25C 3/02; C25B 9/23; B01J 39/12

(57) ABSTRACT

The present disclosure is intended to provide an electrolyzer capable of selectively recovering lithium. The electrolyzer recovers lithium ions Li⁺ from a material M. The electrolyzer includes: a pair of electrodes; and a cation exchange membrane provided between the pair of electrodes and having a lithium ion conductivity. The cation exchange membrane allows, among cations contained in the material M, more lithium ions Li⁺ to pass therethrough than other cations Ca²⁺ and Na⁺. The electrolyzer is configured to apply a voltage between the pair of electrodes.

This application is based on and claims the benefit of priority from Japanese Patent Application 2020-045913, filed on 17 Mar. 2020, the content of which is incorporated herein by reference.

### BACKGROUND OF THE INVENTION

### Field of the Invention

The present disclosure relates to an electrolyzer.

### Related Art

A technique for recovering lithium from seawater or electrolytic solutions of used batteries has been known. According to this known technique, an adsorbent, such as a manganese oxide, is used to adsorb lithium ions, and the lithium ions are then desorbed from the adsorbent to be recovered. (see, for example, Patent Document 1).

Patent Document 1: Japanese Unexamined Patent Application (Translation of PCT Application), Publication No. 2012-504190

### SUMMARY OF THE INVENTION

However, according to the technique described above, the adsorbent acts on not only lithium, but also metals, such as calcium and sodium. It is therefore difficult to selectively recover lithium by way of the technique described above.

The present disclosure has been attained in view of the foregoing background. It is an object of the present disclosure to provide an electrolyzer capable of selectively recovering lithium.

A first aspect of the present disclosure is directed to an electrolyzer (e.g., an electrolyzer 1 to be described later) for recovering lithium ions (e.g., lithium ions Li⁺ to be described later) from a material (e.g., a material M to be described later). The electrolyzer includes a pair of electrodes (e.g., a pair of electrodes 3 and 4 to be described later); and a cation exchange membrane (e.g., a cation exchange membrane 5 to be described later) provided between the pair of electrodes and having a lithium ion conductivity. The cation exchange membrane allows, among cations contained in the material, more lithium ions to pass therethrough than other cations (e.g., calcium ions Ca²⁺ and sodium ions Na⁺ to be described later).

According to the first aspect, use of the cation exchange membrane that allows more lithium ions to pass therethrough than other cations contained in the material makes it possible to selectively recover lithium (lithium hydroxide). Thus, according to the first aspect, lithium (lithium hydroxide) can be recovered in high yield from, for example, seawater.

A second aspect of the present disclosure is an embodiment of the first aspect. In the second aspect, the electrolyzer may further include a voltage application device configured to apply a voltage between the pair of electrodes.

According to the second aspect, the provision of the voltage application device configured to apply a voltage between the pair of electrodes promotes an oxidation reaction and a reduction reaction at the respective electrodes, thereby increasing a rate at which lithium is recovered.

A third aspect of the present disclosure is an embodiment of the first or second aspect. In the third aspect, the material may include an organic solution or a saturated aqueous solution, and the cation exchange membrane may include LTAP-base ceramic having a NASICON type crystal structure.

According to the third aspect, the LTAP-base ceramic having the NASICON type crystal structure is used as the cation exchange membrane capable of allowing more lithium ions to pass therethrough than other cations contained in the material, and the organic solution or the saturated aqueous solution is used as the material. This feature makes it possible to selectively recover lithium (lithium hydroxide), while inhibiting the cation exchange membrane from deteriorating.

A fourth aspect of the present disclosure is an embodiment of the first or second aspect. In the fourth aspect, the material may include an aqueous solution, and the cation exchange membrane may include LTAP-base ceramic having a NASICON type crystal structure, and may have a surface coated with a coating.

According to the fourth aspect, the LTAP-base ceramic having the NASICON type crystal structure and having a surface coated with the coating is used as the cation exchange membrane capable of allowing more lithium ions to pass therethrough than other cations contained in the material. Although the aqueous solution is used as the material, this feature makes it possible to selectively recover lithium (lithium hydroxide), while inhibiting the cation exchange membrane from deteriorating.

A fifth aspect of the present disclosure is an embodiment of the fourth aspect. In the fifth aspect, the coating may include lithium phosphorus oxynitride glass.

According to the fifth aspect, the surface of the cation exchange membrane including the LTAP-base ceramic having the NASICON type crystal structure is coated with lithium phosphorus oxynitride glass. This feature can more reliably inhibit the cation exchange membrane from deteriorating due to the aqueous solution.

The present disclosure provides an electrolyzer capable of selectively recovering lithium.

### BRIEF DESCRIPTION OF THE DRAWINGS

FIG. 1 is a diagram schematically showing an electrolyzer according to an embodiment of the present disclosure.

### DETAILED DESCRIPTION OF THE INVENTION

An embodiment of the present disclosure will be described in detail with reference to the drawing.

### First Embodiment

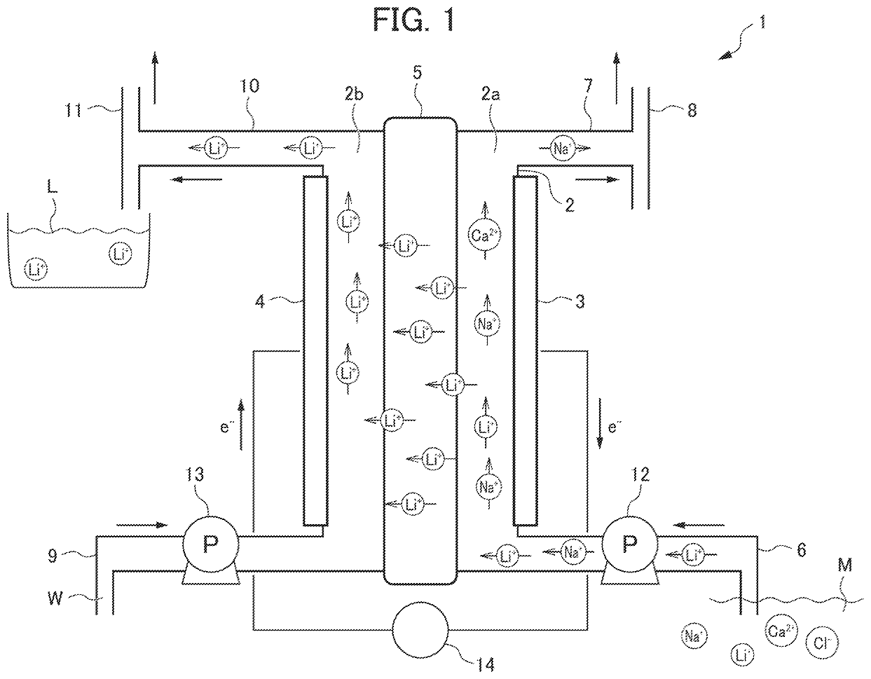

First, a configuration of an electrolyzer 1 according to a first embodiment will be described with reference to FIG. 1. FIG. 1 is a diagram schematically showing the electrolyzer 1.

As shown in FIG. 1, the electrolyzer 1 includes a central flow path 2, a pair of electrodes 3 and 4, a cation exchange membrane 5, a material-side inflow path 6, a drainage path 7, a material-side exhaust path 8, a water-side inflow path 9, a lithium recovery path 10, a recovery-side exhaust path 11, a material-side pump 12, a water-side pump 13, and a power supply device 14.

The central flow path 2 is provided with the pair of electrodes 3 and 4 on both sides thereof. The central flow path 2 is divided into two flow regions 2a and 2b by the cation exchange membrane 5 disposed between the pair of electrodes 3 and 4. The central flow path 2 is configured such that lithium ions Li⁺ move from the flow region 2a to the flow region 2b through the cation exchange membrane 5. The flow region 2a connects the material-side inflow path 6 to the drainage path 7, and causes a material M introduced through the material-side inflow path 6 to flow into the drainage path 7. The flow region 2b connects the water-side inflow path 9 to the lithium recovery path 10. In the flow region 2b, a low-concentration lithium hydroxide aqueous solution W introduced through the water-side inflow path 9 is treated and converted into a high-concentration lithium hydroxide aqueous solution L containing a high-purity lithium hydroxide (with a purity higher than 99%). The flow region 2b causes the high-concentration lithium hydroxide aqueous solution L to flow into the lithium recovery path 10. Examples of the material M include organic solutions collected from used lithium ion batteries and saturated aqueous solutions (e.g., seawater subjected to saturation treatment). The material M contains, for example, calcium ions Ca²⁺, sodium ions Na⁺, and chloride ions Cl⁻, in addition to lithium ions Li⁺.

The pair of electrodes 3 and 4 are disposed on both sides of the central flow path 2. When the power supply device 14 passes a direct current, electrons e⁻ move from the electrode 3 stable in anode dimensions to the electrode 4 stable in cathode dimensions. The electrode 3 is constituted by, for example, a titanium mesh coated with iridium. The electrode 4 is constituted by, for example, by a nickel mesh. The pair of electrodes 3 and 4 are energized such that a current of 25 mA/cm² passes at an arbitrary voltage.

The cation exchange membrane 5 is provided between the pair of electrodes 3 and 4, and divides the central flow path 2 into the two flow regions 2a and 2b. The cation exchange membrane 5 has a lithium ion conductivity. The cation exchange membrane 5 is characterized by allowing passage of only lithium ions Li⁺ among the cations contained in the material M, while blocking other cations (e.g., calcium ions Ca²⁺ and sodium ions Na⁺). Specifically, the cation exchange membrane 5 allows chemical reactions (2Cl⁻→Cl₂+2e⁻) to proceed in the material M flowing through the flow region 2a, while allowing a chemical reaction (2H⁺+2e⁻→H₂; 2OH⁻+2Li⁺→2LiOH) to proceed in the low-concentration lithium hydroxide aqueous solution W flowing through the flow region 2b, so that lithium ions Li⁺ move from the flow region 2a to the flow region 2b. The chemical reactions take place even when no voltage is applied between the pair of electrodes 3 and 4. However, application of a voltage between the pair of electrodes 3 and 4 promotes the chemical reactions.

To be specific, it is preferable to use, as the cation exchange membrane 5 characterized by allowing only lithium ions to pass therethrough and blocking the other cations contained in the material M, LTAP-base ceramic having a Na super ionic conductor (NASICON) type crystal structure as a rhombohedral crystal, the LTAP being described as Li_{1+x+y}AlₓTi₂₋ₓSi_{y}P_{3-y}O₁₂ (x=0.3, y=0.2). The cation exchange membrane 5 preferably has a lithium selectivity of 99% or greater.

The material-side inflow path 6 is connected to the flow region 2a of the central flow path 2, and causes the material M to flow into the flow region 2a.

The drainage path 7 is connected to flow region 2a of the central flow path 2, and causes the material M treated in flow region 2a to flow therethrough.

The material-side exhaust path 8 is an exhaust path branching off from the drainage path 7, and exhausts gas (e.g., chlorine Cl₂) generated from the material M treated in the flow region 2a.

The water-side inflow path 9 is connected to the flow region 2b of the central flow path 2, and causes the low-concentration lithium hydroxide aqueous solution W to flow into the flow region 2b.

The lithium recovery path 10 is connected to the flow region 2b of the central flow path 2, and causes the high-concentration lithium hydroxide aqueous solution L containing the high-purity lithium hydroxide to flow therethrough, the high-concentration lithium hydroxide aqueous solution L having resulted from the treatment of the low-concentration lithium hydroxide aqueous solution W in the flow region 2b.

The recovery-side exhaust path 11 is an exhaust path branching off from the lithium recovery path 10, and exhausts gas (e.g., hydrogen H₂) generated from the low-concentration lithium hydroxide aqueous solution W treated in the flow region 2b.

The material-side pump 12 is provided on the material-side inflow path 6, and conveys the material M in the material-side inflow path 6 to the flow region 2a of the central flow path 2.

The water-side pump 13 is provided on the water-side inflow path 9, and conveys the low-concentration lithium hydroxide aqueous solution W in the water-side inflow path 9 to the flow region 2b of the central flow path 2.

The power supply device 14 is electrically connected to the pair of electrodes 3 and 4, and passes a direct current to the pair of electrodes 3 and 4 as necessary.

Next, it will be described how the electrolyzer 1 operates, with reference to FIG. 1.

As shown in FIG. 1, when the material-side pump 12 and the water-side pump 13 are driven, the material M passes through the material-side inflow path 6 to flow into the flow region 2a of the central flow path 2, while the low-concentration lithium hydroxide aqueous solution W passes through the water-side inflow path 9 to flow into the flow region 2b of the central flow path 2.

The cation exchange membrane 5 allows the chemical reactions (2Cl⁻→Cl₂+2e⁻) to proceed in the material M flowing through the flow region 2a, while allowing the chemical reaction (2H⁺+2e⁻→H₂; 2OH⁻+2Li⁺2LiOH) to proceed in the low-concentration lithium hydroxide aqueous solution W flowing through the flow region 2b, so that lithium ions Li⁺ move from the flow region 2a to the flow region 2b.

The treated material M flows out of the flow region 2a of the central flow path 2 to enter the drainage path 7. The gas (chlorine Cl₂) generated from the material M is exhausted through the material-side exhaust path 8. The high-concentration lithium hydroxide aqueous solution L containing the high-purity lithium hydroxide, which has resulted from the chemical reaction of the low-concentration lithium hydroxide aqueous solution W, flows out of the flow region 2b of the central flow path 2 to enter the lithium recovery path 10. The gas (hydrogen H₂) generated from the low-concentration lithium hydroxide aqueous solution W is exhausted through the recovery-side exhaust path 11.

The electrolyzer 1 according to the present embodiment exerts the following effects. The electrolyzer 1 according to the present embodiment includes the cation exchange membrane 5 having a lithium ion conductivity and characterized by allowing, among cations contained in the material M, more lithium ions to pass therethrough than other cations. This feature makes it possible to selectively recover lithium (lithium hydroxide). Thus, according to the present embodiment, lithium (lithium hydroxide) can be recovered in high yield from, for example, seawater.

The present embodiment includes the power supply device 14 configured to pass a direct current between the pair of electrodes 3 and 4. This feature promotes the oxidation reaction and the reduction reaction at the respective electrodes, thereby increasing a rate at which lithium is recovered.

In the present embodiment, an organic solution or a saturated aqueous solution is used as the material M, and the LTAP-base ceramic having the NASICON type crystal structure is used as the cation exchange membrane 5. This feature makes it possible to selectively recover lithium (lithium hydroxide), while inhibiting the cation exchange membrane 5 from deteriorating.

### Second Embodiment

Next, a configuration of an electrolyzer 1 according to a second embodiment will be described. In the following, only differences from the first embodiment will be described. The electrolyzer 1 of the second embodiment differs from that of the first embodiment in the following point.

A cation exchange membrane of the present embodiment includes LTAP-base ceramic having a NASICON type crystal structure, and has a surface coated with a coating. In other words, the cation exchange membrane of the second embodiment corresponds to the cation exchange membrane of the first embodiment the surface of which is coated with the coating.

The coating is formed by adsorption through vapor deposition. Examples of the coating include lithium phosphorus oxynitride glass, lithium titanium oxide, lithium lanthanum titanium oxide, and lithium lanthanum zirconium oxide. The coating preferably has a thickness of 10 nm or more and 1000 nm or less. From the viewpoint of electrical resistance of the electrolyzer and durability of the cation exchange membrane, the thickness of the coating is more preferably 100 nm. As a material M, an aqueous solution (e.g., seawater) can be used.

The electrolyzer 1 according to the present embodiment exerts the following effects. In the present embodiment, an aqueous solution is used as the material, and the LTAP-base ceramic including the NASICON type crystal structure and having a surface coated with the coating is used as the cation exchange membrane. Although an aqueous solution is used as the material, this feature makes it possible to selectively recover lithium (lithium hydroxide), while inhibiting the cation exchange membrane from deteriorating.

In the present embodiment, lithium phosphorus oxynitride glass is used as the coating. Thus, the surface of the cation exchange membrane including the LTAP-base ceramic having the NASICON type crystal structure is coated with lithium phosphorus oxynitride glass. This feature can more reliably inhibit the cation exchange membrane from deteriorating due to the aqueous solution.

Note that the embodiments described above are not intended to limit the present disclosure. The scope of the present disclosure encompasses modifications, improvements, etc. that are made within the range where the object of the present disclosure can be achieved. For example, the electrolyzer may further include a heating device for heating the material and the electrolyze. Heating the material and the electrolyzer by the heating device promotes the oxidation reaction and the reduction reaction at the respective electrodes, thereby increasing a rate at which lithium is recovered. In the embodiments described above, a membrane that allows only lithium ions Li⁺ to pass therethrough is used as the cation exchange membrane 5. However, a cation exchange membrane that has a lithium ion conductivity and is characterized by allowing, among cations contained in the material M, more lithium ions Li⁺ to pass therethrough than other cations (e.g., calcium ions Cat²⁺ and sodium ions Na⁺) may be used as the cation exchange membrane 5.

### EXPLANATION OF REFERENCE NUMERALS

1: Electrolyzer

2: Central Flow Path

2a, 2b: Flow Region

3, 4: Electrode

5: Cation Exchange Membrane

6: Material-Side Inflow Path

7: Drainage Path

8: Material-Side Exhaust Path

9: Water-Side Inflow Path

10: Lithium Recovery Path

11: Recovery-Side Exhaust Path

12: Material-Side Pump

13: Water-Side Pump

14: Power Supply Device

M: Material

W: Low-Concentration Lithium Hydroxide Aqueous Solution

L: High-Concentration Lithium Hydroxide Aqueous Solution

L⁺: Lithium Ion

Ca²⁺: Calcium Ion (Other Cations)

Na⁺: Sodium Ion (Other Cations)

Cl⁻: Chloride Ion

e⁻: Electron

What is claimed is:

1. An electrolyzer for recovering lithium ions from a material, the electrolyzer comprising:
a pair of electrodes; and
a cation exchange membrane provided between the pair of electrodes and having a lithium ion conductivity,
the cation exchange membrane allowing, among cations contained in the material, more lithium ions to pass therethrough than other cations.

2. The electrolyzer according to claim 1, further comprising:
a voltage application device configured to apply a voltage between the pair of electrodes.

3. The electrolyzer according to claim 1,
wherein the material comprises an organic solution or a saturated aqueous solution, and
wherein the cation exchange membrane comprises LTAP-base ceramic having a NASICON type crystal structure.

4. The electrolyzer according to claim 1,
wherein the material comprises an aqueous solution, and
wherein the cation exchange membrane comprises LTAP-base ceramic having a NASICON type crystal structure, and has a surface coated with a coating.

5. The electrolyzer according to claim 4,
wherein the coating comprises lithium phosphorus oxynitride glass.
